(19) United States
(12) Patent Application Publication
(10) Pub. No.: US 2007/0029255 A1
(43) Pub. Date: Feb. 8, 2007

(54) Desalination system powered by renewable energy source and methods related thereto

(76) Inventors: Fernando Javier D'Amato, Niskayuna, NY (US); Minesh Ashok Shah, Clifton Park, NY (US); Michael Baldea, Saint Paul, MN (US)

Correspondence Address: GENERAL ELECTRIC COMPANY;GLOBAL RESEARCH, PATENT DOCKET RM. BLDG. K1-4A59, NISKAYUNA, NY, 12309, US

(21) Appl. No.: 11/435,351

(22) Filed: May 16, 2006

Related U.S. Application Data
(60) Provisional application No. 60/706,229, filed on Aug. 3, 2005.

(51) Int. Cl. B01D 61/02

(52) U.S. Cl. 210/637; 210/652; 210/134; 210/143; 210/739; 210/321.65; 210/321.66; 700/273; 703/9

(57) ABSTRACT

Embodiments of the invention relate methods to control a desalination system comprising evaluating physical models sufficient to identify physical constraints, evaluating economic models and wherein evaluating the physical and economic models provides a preliminary configuration for the desalination system to reduce the cost of water and provide operating strategies.

### PRIORITY OF INVENTION

This non-provisional application claims the benefit of priority under 35 U.S.C. § 119(e) to U.S. Provisional Patent Application Ser. No. 60/706,229, filed Aug. 3, 2005, which is herein incorporated in its entirety by reference.

### GOVERNMENT FUNDING

The present subject matter was partially supported by the United States Department of Energy, National Renewable Energies Laboratory, under Agency Contract Number YAM-4-3320-09. The United States government may have certain rights in the invention.

### FIELD OF TECHNOLOGY

Embodiments of the invention relate to operation and control of a desalination system. Particularly, embodiments relate to enhanced operation and control of a desalination system powered by a renewable energy source.

### BACKGROUND

Worldwide water needs are increasing rapidly and factors such as population growth, increased industrial usage and pollution of existing supplies may limit many countries' capability to satisfy freshwater demands in the future. The development of new water resources through the purification of impaired resources is seen as a critical technology for meeting future water needs. Existing desalination techniques are characterized by large energy expenditures to generate potable water. The associated cost of energy is one of the dominant factors in the water desalination economy.

One purification technique, reverse osmosis, is gaining increased acceptance as a viable desalination technique due to its low energy consumption and its design flexibility. But in water starved areas and remote, inland areas where electric grid connectivity is limited, the energy cost associated with reverse osmosis based desalination may render the desalination solution as economically infeasible.

### BRIEF DESCRIPTION

Embodiments of the invention relate to methods to control a desalination system that include evaluating physical models sufficient to identify physical constraints and evaluating economic models. The evaluating of the physical and economic models provides a preliminary configuration for the desalination system to reduce the cost of water and provide operating strategies. Further, embodiments relate to a desalination system comprising a power source and one or more water filtration units. The desalination system is configured and operated by the evaluation of both physical and economic models, which lower the cost of water.

### DESCRIPTION OF THE DRAWINGS

Embodiments of the invention may be understood by referring to the following description and accompanying drawings that illustrate such embodiments. In the drawings:

FIG. 1 illustrates a flow diagram describing a method to control a desalination system powered by a renewable energy source, according to some embodiments of the invention.

FIG. 2 illustrates a flow diagram describing a further method to control a desalination system powered by a renewable energy source, according to some embodiments of the invention.

FIG. 3 illustrates a graphical view of a grid-connected doubly fed induction generator (DFIG) model validated against the power curve of a wind turbine generator, according to some embodiments of the invention.

FIG. 4 illustrates a diagram of a variable speed motor drive and induction motor, according to some embodiments of the invention.

FIG. 5 illustrates a diagram of a variable speed drive and motor model, according to some embodiments of the invention.

FIG. 6 illustrates perspective view of a reverse osmosis membrane module, according to some embodiments of the invention.

FIG. 7 illustrates a cross-sectional view of reverse osmosis membrane modules contained in a high pressure cylindrical vessel, according to some embodiments of the invention.

FIG. 8 illustrates a diagram of a work exchanger energy recovery device, according to some embodiments of the invention.

FIG. 9 illustrates a diagram of flow network, according to some embodiments of the invention.

FIG. 10 illustrates a diagram of a 2-stage RO desalination system utilizing an inter-bank booster pump and feed booster pump, according to some embodiments of the invention.

FIG. 11 illustrates a diagram of a 1-stage RO desalination system, according to some embodiments of the invention.

FIG. 12 illustrates a diagram of a 2-stage RO desalination system utilizing an inter-bank boost pump, according to some embodiments of the invention.

FIG. 13 illustrates a diagram of a 2-stage RO desalination system utilizing a feed booster pump, according to some embodiments of the invention.

FIG. 14 illustrates a graphical view of the maximum permeate flow as a function of available power, according to some embodiments of the invention.

FIG. 15 illustrates a graphical view of the optimal operating parameters as a function of available power, according to some embodiments of the invention.

FIG. 16 illustrates a graphical view of the annual average cost of water for a desalination plant configuration, operated as grid-isolated, as a function of the number of RO vessels installed, according to some embodiments of the invention.

### DETAILED DESCRIPTION

Embodiments of the invention may relate to methods of controlling and optimizing a desalination system powered by a renewable energy source.

References in the specification to “one embodiment,” “an embodiment,” “an example embodiment,” indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one of ordinary skill in the art to affect such feature, structure, or characteristic in connection with other embodiments whether or not explicitly described.

Approximating language, as used herein throughout the specification and claims, may be applied to modify any quantitative representation that could permissibly vary without resulting in a change in the basic function to which it is related. Accordingly, a value modified by a term such as “about” is not to be limited to the precise value specified. In some instances, the approximating language may correspond to the precision of an instrument for measuring the value.

In the drawings, like numerals describe substantially similar components throughout the several views. These embodiments are described in sufficient detail to enable one of ordinary skill in the art to practice the invention.

Embodiments of the invention relate to desalination systems and control methods for hybrid desalination technologies that use renewable power sources as substitutes for well-established desalination technologies that use either fossil fuel power plants or grid energy. Examples of renewable energy sources are wind and solar energy. The main challenges addressed by renewable energy source desalination hybrids are plant design for minimizing the cost of water, operability over a large power envelope, robustness to feedwater variation, and management of multiple, often conflicting, requirements. While a renewable energy source desalination system with advanced operations can be developed, its effectiveness must be measured in terms of its energy consumption and ultimately the cost of water.

Embodiments of the invention effectively deal with the constraints of variable power input on desalination system operations to arrive at processes capable of accommodating a wide range of wind turbine power variation while still remaining economically viable. Embodiments of the invention develop component (physical) models for the major components of the renewable energy source desalination system and their integration into a system-level concept. The component models include wind turbine system, reverse osmosis system, energy recovery devices and energy storage. The component models provide information for one or more effectors to modify an operating point in the desalination system. An effector may be defined as a device used to produce a desired change in an object in response to input, for example. Some types of effectors used may be valves or variable frequency drives, for example. The effectors may also respond to external disturbances, such as feed water temperature or concentration and variations in the power supplied to the desalination system, for example.

Further, embodiments of the invention develop an integrated energy and water cost model that can be used to evaluate various system configurations. In addition, the application and analysis of the various models provide a program for handling power fluctuations while meeting water quality requirements with the lowest cost of water. Embodiments of the invention also relate to methods for sizing and evaluating a renewable energy source desalination system while either grid connected or grid isolated with energy storage. Embodiments of the invention are illustrated generally with the use of wind as the renewable energy source and reverse osmosis as the desalination mechanism, but the embodiments are not so limited and can be applied to various applications.

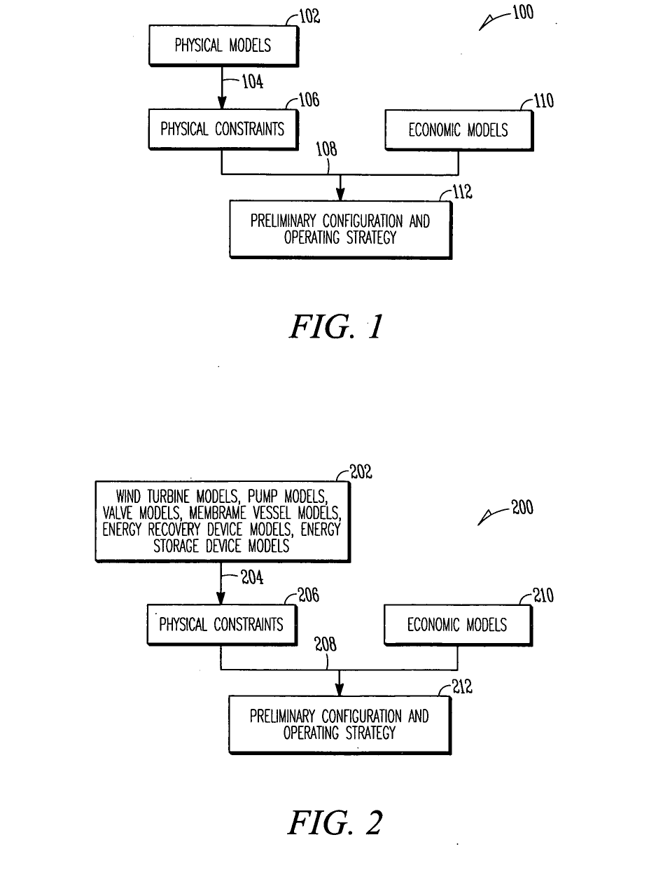

Referring to FIG. 1, a flow diagram describing a method 100 to control a desalination system powered by a renewable energy source is shown, according to some embodiments of the invention. Physical models 102 are evaluated 104 sufficient to provide physical constraints 106, including variations of a source. The physical models 102 and their physical constraints 106 are evaluated 108 with the economic models 110 to provide a preliminary configuration and operating strategy 112.

Referring to FIG. 2, a flow diagram describing a further method 200 to control a desalination system powered by a renewable energy source is shown, according to some embodiments of the invention. Physical models of such components as wind turbines, pumps, valves, membrane vessels, energy recovery devices, energy storage devices 202 are evaluated 204 sufficient to provide physical constraints 206. The physical models 202 and their physical constraints 206 are evaluated 208 with the economic models 210 to provide a preliminary configuration and operating strategy 212.

Physical Models

Wind Model

Wind speed is highly variable, geographically and temporally, and varies over a multitude of temporal and spatial time scales. In terms of power generation using a wind turbine, this variation is amplified by the fact that the available energy in the wind varies as the cube of the wind speed. Careful consideration of the location/site of a wind farm or any other plant that relies on the exploitation of the wind resource for power generation is essential in order to ensure superior economic performance. Wind is driven by differences in temperature of the Earth's surface. Geographic variations in wind speed thus originate in differences in solar exposure between different geographic regions. Surface heating by the sun is stronger during daytime, close to the equator and on land masses. Warm air rises and circulates in the atmosphere before it sinks back to cooler regions. This results in various wind characteristics, such as: daily peak wind speed caused by the rotation of the earth, characteristic wind directions on various locations of the globe caused by the air flow between poles and the equator, and local wind effects caused by the non-uniformity of the Earth's surface (e.g., characteristic diurnal wind speeds near coasts or in mountains). Surface roughness and the nature of the terrain in a specific location also impact on the variation of the wind speed.

From a temporal point of view, wind speeds vary over several time scales, such as slow long term variation (year-to-year), annual time scales, short-term (turbulent) variations, synoptic and diurnal variations and turbulence. Annual variations are of particular importance as they are used in modeling the average annual power generation by a wind turbine and also in evaluating the average cost of water (COW) produced with a wind powered water desalination plant.

While year-to-year variations in the annual mean wind speeds are difficult to predict, wind speed variations during one year (annual and seasonal variation) can be well characterized statistically. The Weibull distribution may be used to give a representation of the distribution of mean wind speeds over a year. The mean wind speed may be defined as the wind speed averaged over a short period of time, such as 10 minutes, for example. The Weibull probability function

$$f ( \overline{V} ) = k \frac{{\overline{V}}^{k - 1}}{{A}^{k}} exp ( - {( \frac{\overline{V}}{A} )}^{k} ) \qquad Eq . 1$$

can be used for determining the average yearly wind speed for a specific location (site),

$$\overline{\overline{V}} = {\int }_{0}^{∞} \overline{V} f ( \overline{V} ) ⅆ \overline{V} \vert \qquad Eq . 2$$

and the probability of the mean wind speed at a site be within a certain wind speed range [ V̅₁, V̅₂]|,

$${P}_{1 , 2} = {\int }_{{\overline{V}}_{1}}^{{\overline{V}}_{2}} f ( \overline{V} ) ⅆ \overline{V} \qquad Eq . 3$$

The scale parameter A and the shape parameter k are determined experimentally from wind speed measurements and are site specific. If k is exactly 2, the distribution is known as a Rayleigh distribution and is typical to many locations.

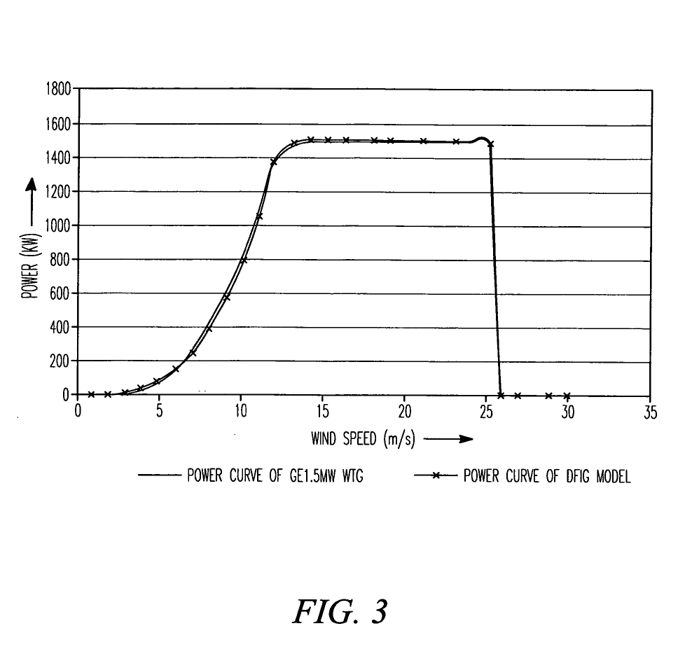

A grid-connected doubly fed induction generator (DFIG) model was validated against the power curve of a 1.5 MW wind turbine generator. The comparison result is shown in FIG. 3.

Variable Speed Drive and Motor Model

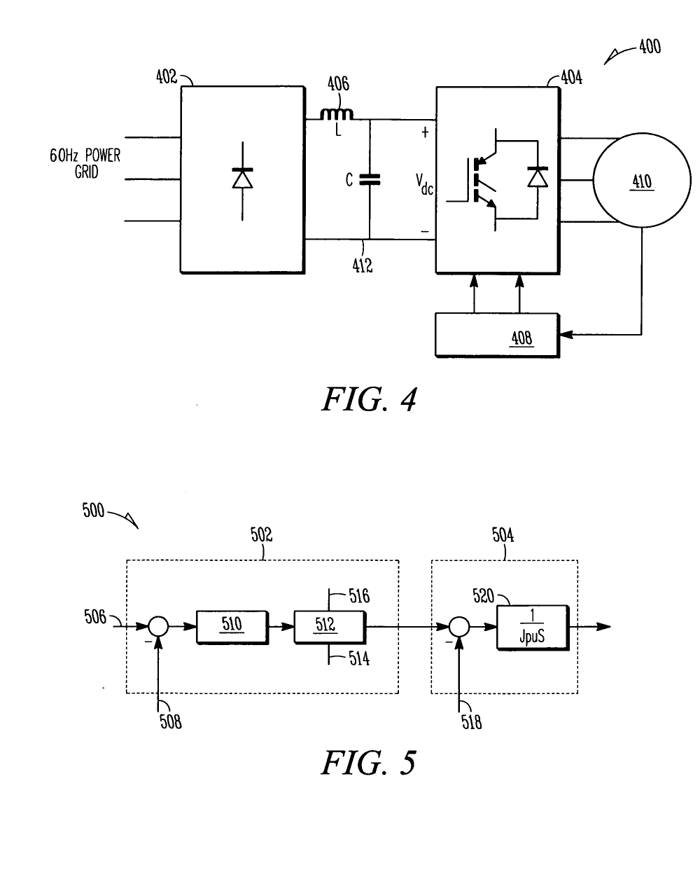

Variable speed drives are major components in the electrical system and are prime movers of the desalination water pumps. They can be controlled and constrained by the desalination system operation requirements as well as the wind turbine generator power and stability requirements. Referring to FIG. 4, a diagram 400 of a variable speed motor drive and induction motor is shown, according to some embodiments of the invention. A typical AC motor drive may comprise a rectifier 402, a DC link capacitor 412 and a variable frequency inverter 404, which regulates the speed (frequency) and torque (current) 408 of the induction motor 410. A filter 406 may be placed between the rectifier 402 and inverter 404.

Because the power electronic controls may have a very high bandwidth and given the relatively large time constant of the desalination system, fast transients may be simplified to only capture the speed (frequency) and torque (current) control behaviors of the machine. A simplified model 500 of variable speed drive 502 and motor 504 is illustrated in FIG. 5, according to some embodiments of the invention. That PI control block 510 is used to regulate speed by measuring the speed feedback 508 from the motor 504, as compared to the speed reference 506. The fast acting current regulator 514 may be replaced by a gain 512 with a variable torque limiter 516, whose value is provided by the wind turbine generator. This ensures that the motor always operates within the available power supplied by the wind turbine generator. The output of the torque regulator may then be subtracted from the load torque 518 with the result fed to the integrator 520 representing the actual machine and palm and inertia. This model has the capability of taking into consideration the variable power (current) from the wind turbine generator and regulating the current and in turn, controlling the torque and speed of the motor 504.

Reverse Osmosis (RO) Membrane Module

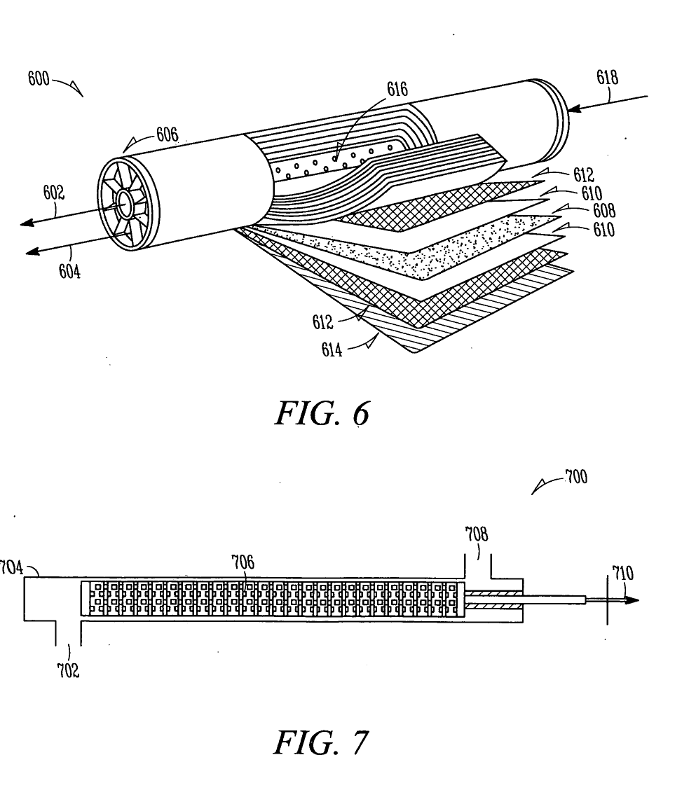

Referring to FIGS. 6-7, a reverse osmosis membrane module 600 is shown and may be contained in a high pressure cylindrical vessel 700, according to some embodiments of the invention. The module 600 may comprise layers such as permeate collection material 608, membrane 610, feed channel spacer 612 and outer wrap 614 wound around a perforated central tube 616. The feed stream enters the module and exits as permeate 602 and concentrate 604. An anti-telescoping device 606 is located at one end. The high pressure cylindrical vessel 700 comprises the vessel structure 704 and spiral wound elements 706. Feedwater enters at 702 and exits as concentrate flow 708 and permeate flow 710. In this arrangement, water with high salinity content is pressurized to overcome the osmotic pressure against the membrane surface 610. By means of the RO principle, low salinity water permeates through the membrane 610 and it is collected in the central perforated tube 616. For a given feedwater state (pressure, concentration and temperature), the membrane physical characteristics dictate the permeate flow and concentration. The RO elements are designed for continuous operation, receiving a constant stream of feedwater and generating constant streams of permeate and brine (or concentrate). Standard RO plants use constant operating pressures and flows, possibly considering long-term adjustments to accommodate changes in the feedwater properties and changes in the filtration process due to membrane degradation.

The model developed for the RO element predicts the concentrate pressure flow rates of permeate and concentrate streams and their corresponding concentrations given the feed state (flow rate, concentration, pressure and temperature) and the permeate pressure. The functional relationship is given by
[Pc,Qp,Qc,Cp Cc]=RO_element(Qf,Cf,Pf,Pp,T) Eq. 4
where Pc is concentrate pressure (Pa), Qp is permeate flow rate (m³/s), Qc is concentrate flow rate (m³/s), Cp is permeate pressure (Pa), Cc is concentrate concentration (kg/m³), Qf is feed flow rate (m³/s), Cf is feed concentration (kg/m³), Pf is feed pressure (Pa), Pp is permeate pressure (Pa) and T is the feed temperature (° C.).

The model used to predict the membrane filtration behavior is the so called “solution-diffusion” model. This model takes into account the effect of membrane polarization, that is the increment of concentration near the membrane interface in the brine channel, due to the salt released by the permeate flow. The model of the invention solves the following solution-diffusion equations to calculate membrane behavior.
J_{w}=A{p_{f}−pₚ−└π( c̅ₘ)−π(cₚ)┘}
Jₛ=J_{w}cₚ=B( c̅ₘ−cₚ)
c̅ₘ=( c̅− c̅·psg)e^{j}^{_{w}}^{lk}+psg c̅ Eq. 5
where J_{w} is the water volumetric flux through the membrane (cm³/cm²/s), Jₛ is the salt mass flux through the membrane (g/cm²/s), A is the water permeability (cm/s/atm), B is the salt permeability (cm/s), k is the mass transfer coefficient (cm/s), c is the concentration (g/l), p is the pressure (atm), c̅ is (c_{f}+c_{c})/2|, π(c)| is the osmotic pressure corresponding to concentration c (atm), and psg is cₚ/cₘ salt passage. Subindex f respresents feed, subindex p is the permeate, subindex m is the membrane interface and subindex c is the concentrate. The solution diffusion model depends critically on the membrane parameters k, A and B. The mass transfer coefficient k depends on the water properties and the geometric dimensions of the spiral wound design. The permeabilities can be corrected by temperature and pressure. The model according the embodiments of the present invention incorporates correction of permeabilities by temperature effects.

The model for the pressure drop in the brine channel, DP, may be described by

$$DP = {K ( \frac{{Q}_{f} + {Q}_{c}}{2} )}^{1.5} \qquad Eq . 6$$

where K is a constant.

The spiral wound elements must satisfy a set of operational constraints to achieve the expected performance in terms of product quality, energy efficiency, maintenance costs and membrane life. Table 1 summarizes the set of RO element constraints for a seawater application.

TABLE 1

| Parameter | | Limit | Meaning |
|---|---|---|---|
| Cₘ/ C̅ | < | 1.2 | Polarization |
| Pf | < | 1200 psi | Feed pressure |
| Qc | > | 15 gpm | Concentrate flow |
| J_{w} | < | 20.6 gfd | Permeate flux through membrane |
| DP | < | 10 psi | Pressure drop in the brine channel |

Table 2 summarizes the set of RO element constraints associated with brackish water.

TABLE 2

| Parameter | | Limit | Meaning |
|---|---|---|---|
| Cₘ/ C̅ | < | 1.2 | Polarization |
| Pf | < | 600 psi | Feed pressure |
| Qc | > | 15 gpm | Concentrate flow |
| J_{w} | < | 28.3 gfd | Permeate flux through |
| | | | membrane |
| DP | < | 10 psi | Pressure drop in the brine |
| | | | channel |

The following simplifying assumptions may be used for the RO models:

1) The input/output behavior of one spiral wound element can be predicted in its whole operating range using the solution-diffusion equations with average water state along the element.

2) The flow within the RO element develops instantaneously for changes in the membrane pressure.

3) The time response of concentration c to changes in the model inputs can be modeled as in Eq. 7, where cₛₛ is the steady state value for concentration given by the solution-diffusion equations, s is the frequency variable for the Laplace transformation and T is the time constant in seconds.

$$c = \frac{1}{Ts + 1} {c}_{ss} \qquad Eq . 7$$

4) The permeabilities A and B are assumed independent of the membrane pressure.
5) Membrane degradation effects are not considered.
The RO element model can be used to represent the behavior of different membrane elements, since the transport parameters are calculated based on geometric data and nominal permeability values, which are typically available from membrane manufacturers.
RO Vessels and Banks

A desalination plant comprises one or more water filtration units, which may be reverse osmosis vessels, for example. Under typical operating conditions, a single RO element produces a permeate flow that is a fraction of the feed flow (such as 7%, for example). This ratio describes the element's recovery. To achieve higher recoveries and reduce the impact of pretreatment costs and vessel capital costs, it is common practice to use arrangements of several RO elements connected in series within the same vessel. The physical model for a vessel with multiple RO elements is obtained by concatenation of several models of RO elements, connecting the concentrate channel of a given element to the feed channel of the following one. A model of an n-element vessel is obtained by the repeated use of the element model in Eq. 4, as follows

$$\begin{matrix}[ {Pc}_{k} , {Qp}_{k} , {Qc}_{k} , {Cp}_{k} , {Cc}_{k} ] = RO\_element ( {Qf}_{k} , {Cf}_{k} , {Pf}_{k} , {Pp}_{k} , T \\ with {Qf}_{k} = {Qc}_{k - 1} , {Cf}_{k} = {Cc}_{k - 1} , {Pf}_{k} = {Pc}_{k - 1}\end{matrix} \vert \qquad Eq . 8$$

in which the inputs are Qf₁, Cf₁, Pf₁, Pp₁ and T. The outputs are Pcₙ, Qpₙ, Qcₙ, Cpₙ and Ccₙ. The maximum flow rate that a vessel can handle is limited by the maximum diameter of the associated membrane element. To obtain higher flows, several vessels may be connected in parallel to achieve the desired flow rate. In addition to Tables 1 and 2, the following constraints are observed for the RO system.

TABLE 3

| Parameter | | Limit | Rationale for Constraint |
|---|---|---|---|
| $\vert \frac{ⅆ {P}_{f}}{ⅆ t} \vert$ | < | 7.25 psi/s | Feed pressure rate of change at the first element in an RO bank |
| DP | < | 58 psi | Pressure drop across an RO vessel |

Energy Recovery

Reverse osmosis desalination processes are characterized by relatively small pressure drops across the vessel brine channel. The concentrate flow conserves a large proportion of the energy available in the feedwater flow. In order to reduce the energy expended in feed water pressurization (thereby improving the energy efficiency of RO desalination), numerous devices have been designed to recover the energy in the concentrate stream and transfer it back to the feed flow stream. These devices are known as Energy Recovery Devices (ERDs).

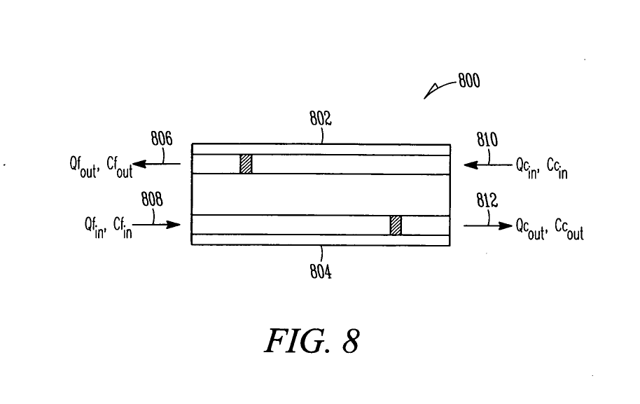

The most efficient ERDs use positive displacement technology and can achieve efficiencies in the range of 92-96%. Referring to FIG. 8, a diagram of a work exchanger energy recovery device 800 is shown, according to some embodiments of the invention. The work exchanger 800 transfers energy from the concentrate flow 810, 812 to the feedwater flow 806, 808 by means of a set of cylindrical vessels and low friction pistons 802, 804 that travel along the vessel by the pressure difference. Typically, while one vessel is in work stroke 802 pressuring the feedwater 806, the other one 804 is in flush stroke, discarding the concentrate 812 at a low pressure. The work exchanger 800 achieves nearly continuous operation using a set of valves and a control system to reverse the piston movements at the end of each stroke.

The ERD model calculates the feedwater input and output flows Qfᵢₙ, and Qfₒᵤₜ, and feedwater outputs concentration Cfₒᵤₜ, and pressure Pfₒᵤₜ as a function of the input concentrations Cfᵢₙ, Ccᵢₙ and the pressures Pcᵢₙ, Pfᵢₙ and Pcₒᵤₜ. The functional relationship of this model is given by
(Qcin, Qfout, Cfout, Pfout]=WEER (CCin, Cfin, PCin, Pfin, Pcout)| Eq. 9.
The ERD model accounts for leakage flow in the valves, mixing between concentrate and feedwater within the vessel, and overall pressure/flow characteristics, as given by the product specifications. It is usually assumed when using this model that the flow within the ERD develops instantaneously with changes in the input and output pressures.
Water Pumps

Models for water pumps are necessary to represent the pressure heads obtained by the high pressure, booster and interstage pumps at design and off-design conditions, for any given rotational speed and flow. The pump models have the functional representation
[H, η, P, T]=PMP_{—}HP{Q,N) Eq. 10
where H is the pressure head across the pump (psi), η is the pump efficiency, P is the power consumed (W) and T is the torque (lb/ft). The pump model uses a parametric implementation of pump characteristics, that is easily adapted for different commercial products and uses standard corrections for speed and flow at off-design conditions.
Energy Storage

A battery model describes the impact of energy storage in the operating strategies for grid connected and grid isolated wind turbine configuration. The battery model has one state, the battery charge x_{c} and is given by
\dot{x}_{b}=Bₚ
|Bₚ|≦Bₚ_{ₘₐₓ}
x_{b}_{ₘᵢₙ}≦x_{b}<x_{b}_{ₘₐₓ} Eq. 11
where Bp is power drawn from the battery (W), Bpmax is the maximum charging and discharging rate for the battery (W), X_{b min} is the minimum charge (Joule) and x_{b max} is the maximum (Joule). The battery model does not account for the effect of temperature, capacity and efficiency degradation, which can affect the performance of the cells.
Valves

The valve model calculates the flow Q as a function of the valve opening y, inlet and outlet pressures P1 and P2, according to

$$Q = {yC}_{v} \sqrt{\frac{( {P}_{1} - {P}_{2} )}{ρ}} \vert \qquad Eq . 12$$

where Cᵥ is the valve flow coefficient, ρ is density (kg/m³) and Q is volumetric flow (m³/s).
Flow Junction

Flow junction models are used to predict the concentration and flow of two or more water streams converging to a single stream by mass balance of water and salt. The functional form is
[Qout, Cout]=FJn(Q1, C1, . . . , Qn, Cn)| Eq. 13
where C1 . . . Cn is the concentration of input streams 1 to n (kg/m³), Q1 . . . Qn is the flow of input streams 1 to n (m³/s), Cout is the concentration of output stream (kg/m³) and Qout is the flow of output stream (m³/s). It is assumed that all the converging streams are at the same pressure and temperature.
Flow Network

The flow network model is used to calculate pressures, flows and concentrations throughout an RO plant, both at nominal as well as off-design conditions. The RO plant consists of a set of RO banks, pumps, valves and flow junctions interconnected through pipes. The operating point of the system is dictated by the environment variables (pressures, temperatures and concentrations at the system interface), as well as by the setpoints of the available control knobs.

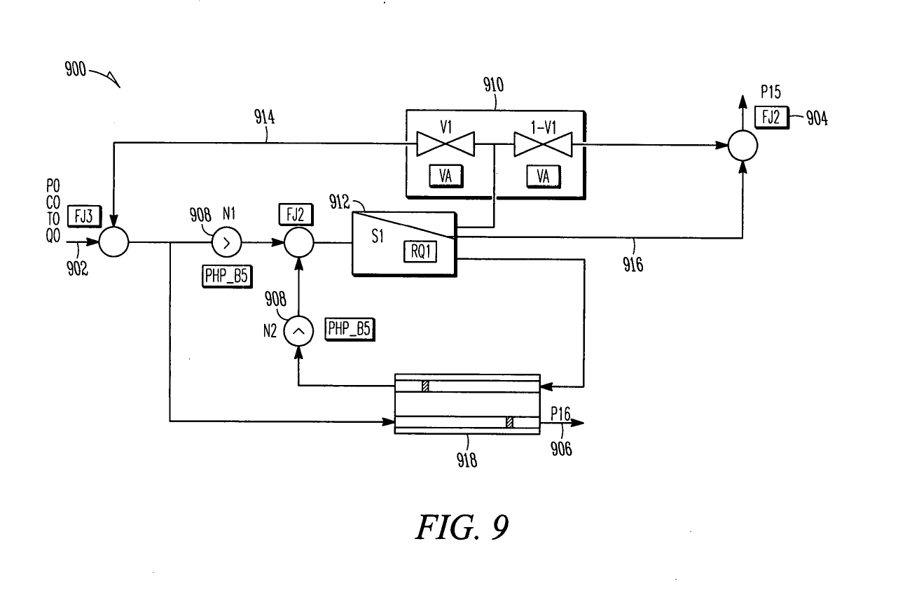

Referring to FIG. 9, a diagram of a flow network 900 is shown, according to some embodiments of the invention. The external pressures are the feed pressure 902, the permeate pressure 904 and brine discharge pressure 906. The control variables are the pump speeds 908, the valve opening 910 and the number of active vessels 912. The good permeate line 916 and bad permeate line 914 are also indicated. The network model solves a set of algebraic equations (the pressure/flow characteristics and the energy and mass balances of every component) using a modified Newton-Raphson method. It is assumed that the water temperature remains constant throughout the RO system and that the friction losses are small enough to neglect temperature changes in the water. The limits of operation of the RO network are given by the maximum and minimum speeds of the electrical motors and pumps, maximum and minimum flows in the ERD 918, water quality requirements, membrane limitations and the maximum number of vessels. Table 4 further shows the variables in FIG. 9.

TABLE 4

| Parameter | Description |
|---|---|
| S1 | Number of vessels in stage 1 |
| S2 | Number of vessels in stage 2 |
| N1 | High pressure pump speed |
| N2 | Booster pump speed |
| N3 | Interstage pump speed |
| V1 | Stage 1 permeate recycle valve position |
| V2 | Stage 1 permeate output valve position |
| V3 | Stage 2 permeate recycle valve position |
| V4 | Stage 2 permeate output valve position |

Cost of Water (COW) Calculation
Steady State Cost Model

The cost model for the wind powered desalination system consists of two major parts, the capital costs associated with purchased equipment and installed facilities required, and the operating costs incurred to produce fresh water permeate. Each specific cost model is based on the model analysis of the combined wind-RO system configuration. The wind power is used to drive a 1.5 mega-watt (MW) electrical turbine that has a 36% capacity factor, which means that 540 kW of power are generated on average over the course of a year for a standard wind profile. Such a model includes the capital costs associated with purchased equipment and installed facilities and the operating costs incurred to produce freshwater permeate. The capital costs include the purchased equipment costs, the direct capital costs and the indirect capital costs. The operating cost model includes total fixed costs related to interest, taxes, insurance, depreciation, labor and maintenance. In addition, the operating costs include variable operating costs, such as raw materials, utilities and waste disposal costs. Any variability in the economic model comes from the variable costs and not the fixed costs.

Cost of Water and Wind Statistical Representation

Due to the stochastic nature and variability of the wind resource, (and consequently, the variability of the power generated by a wind turbine) the reverse osmosis water desalination plant is designed to operate at different levels of available power. In particular, for grid-isolated plants, the amount of permeate (fresh water obtained by desalination) will vary with the wind speed and with the power supplied to the desalination system. Specifically, at higher wind speeds, when more power is available, higher flow rates can be processed and more permeate can be obtained and vice-versa. The cost of water produced by the RO desalination plant is expected to vary over time, and computing an average/levelized cost of water over one year of operation is essential for realistically evaluating the economic performance of wind-powered RO desalination.

The RO desalination plant configuration that produces the lowest cost of water is determined in two steps: First, the optimal operating parameters of the RO desalination plant are computed such that the maximum permeate flow is obtained for a given power level. Second, the physical parameters calculated above are considered in light of the previously mentioned cost models and statistical wind speed data to size the RO plant so that the average yearly cost of water is minimized.

In the first step, the input parameters available to control the plant operation are the speeds N (in rpm) of the pumps in the plant, the number S of RO vessels used in the RO banks, as well as the valve opening V of the permeate recycle streams. While determining the optimal setpoints for the above parameters at each power setting, all economic and physical constraints imposed on the operation of the plant should be satisfied. The optimization problem

$$\begin{matrix}\begin{matrix}\begin{matrix}{max}_{N , S , V} Permeate Flowrate \\ subject to \text{:}\end{matrix} \\ Power = Available Power\end{matrix} \\ Operating Constraints\end{matrix} \vert \qquad Eq . 14$$

may be solved considering that the available power ranges between 70 and 1500 kW and results in a table of optimal (from a maximum permeate flow rate point of view) input parameters as a function of the power available for operating the RO plant. An example of the results table is shown:

TABLE 5

| | | | | Maximum |
|---|---|---|---|---|
| Available | Optimal | Optimal | Optimal recycle | permeate |
| Power, kW | Nᵢ rpm | Sᵢ (vessels) | Vᵢ | flow, Qₚ, gpm |
| P₁ | N_{i,1} | S_{i,1} | V_{i,1} | Q_{p,1} |
| . | . | . | . | . |
| . | . | . | . | . |
| . | . | . | . | . |
| Pₙ | N_{i,n} | S_{i,n} | V_{i,n} | Q_{p,n} |

In Table 5, index j refers to the equipment or stream number. For example, if there are several pumps installed in the plant, each will have its optimal setting: pump 2 at an available power P₁ would have the optimal rpm N_{2,1}.

In step two, the statistical description of the wind resource is employed in order to obtain an average/levelized specific cost of water for a plant in which Sₖ RO vessels are installed:

$${SCOW}_{k} = {\sum }_{j = 1}^{n} SCOW ( {S}_{k} , ROPower , {\overline{V}}_{j} , {\$}_{e} ) \cdot {w}_{j} \vert \qquad Eq . 15$$

In Eq. 15, SCOW(Sₖ,ROPower, V̅ⱼ,$ₑ)| represents the specific cost of water (in $/m³) for the RO desalination plant with Sₖ vessels, when operated at power consumption ROPower, with the wind turbine producing the amount of power corresponding to the mean wind speed V̅ⱼ, and the grid energy prices given by $ₑ. The function SCOW(Sₖ, ROPower, V̅ⱼ, $ₑ)| is a functional representation of the specific cost of water calculation algorithm presented earlier. n wind speeds V̅ⱼ are considered, with the representative Weibull probabilities

$${w}_{j} ( {\overline{V}}_{j} ) = {f ( {\overline{V}}_{j} )}^{*} , {\sum }_{j = 1}^{n} {w}_{j} ( {\overline{V}}_{j} ) = 1 \vert .$$

Hence, the average cost is obtained as a weighted average and the probability wⱼ of the mean wind speed V̅ⱼ. For determining SCOW, the power Pⱼ generated by the wind turbine, for a given (Weibull-distributed) mean wind speed V̅^{j}, is computed from the turbine power curve. The Weibull probability density function describes the distribution of mean wind speeds at a standard height and wind speeds are therefore scaled in order to obtain the corresponding mean speeds at the height of the turbine hub:

$${\overline{V}}_{j , hub} = {{\overline{V}}_{j} ( \frac{10 m}{{h}_{hub}} )}^{α} \qquad Eq . 16$$

with α=0.143 being the vertical shear exponent.

The power consumed by the RO plant, ROPower, and the power generated by the wind turbine, Pⱼ, are equal only if a grid-isolated case with no energy storage is considered. For grid-connected configurations, the power consumption of the plant may at times exceed or be surpassed by the amount of power generated. When there exists a mismatch between power production and consumption, the difference can be covered by purchasing energy from or selling energy to the grid. Also, energy can be drawn from or spent on charging a battery system (if such a system is present). Energy purchases and sales have an impact on the specific cost of water, depending on the energy purchase and sale prices, $ₑ, and are accounted for in the SCOW function. No cost is associated with disposing of the excess energy generated by the turbine, in case that energy sale to the grid is not possible.

The function SCOW also takes into account that the plant cost, as well as the specific cost of water, increases as the number of RO vessels installed in the plant, Sₖ, increases. In the cost calculations, it is assumed that the operation of the plant is flexible with respect to the number of RO vessels used. That is, when Sₖ vessels are physically present in the plant, any number 1<S_{actual}<Sₖ of vessels may be used in order to achieve the maximum permeate flowrate for ROPower, the power available.

When no grid connection is available, the plant will idle when the wind turbine does not generate power, the permeate flowrate being reduced to zero. The time intervals when the wind speed is too low for power generation are also accounted for in computing the average specific cost of water. In such cases, SCOW is reduced to the specific fixed cost of the plant.

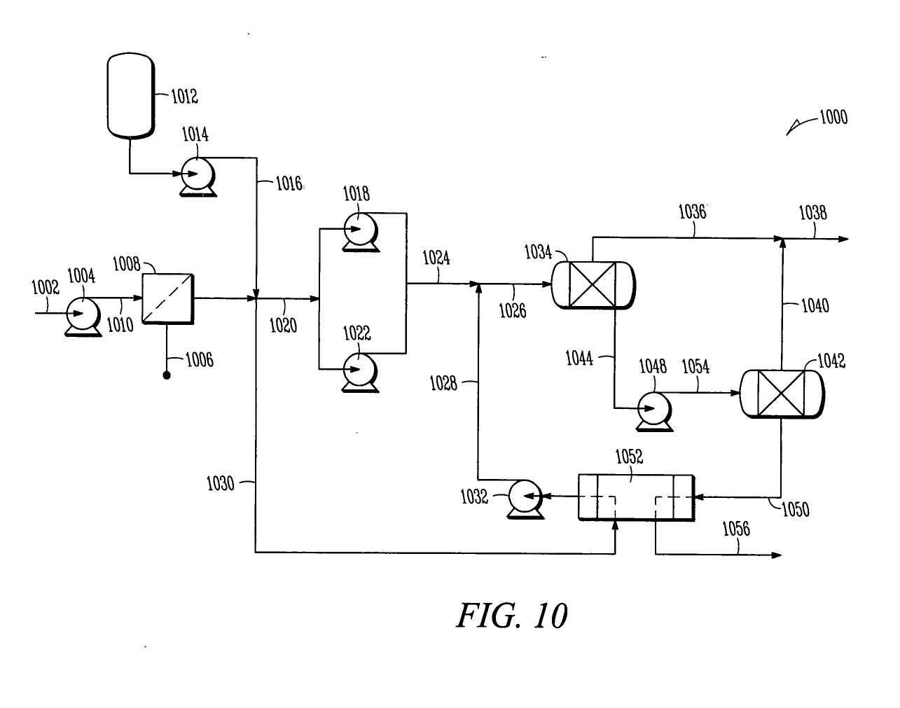

Referring to FIGS. 10-13, some possible RO desalination system configurations are shown, according to some embodiments of the invention.

FIG. 10 illustrates a diagram of a 2-stage RO desalination system 1000 utilizing an inter-bank booster pump 1048 and feed booster pump 1032, according to some embodiments of the invention. The seawater feed 1002 may be fed through a filter pump 1004, through the filter feed 1010 and into a filter 1008. The filter solids 1006 are removed. An acid tank 1012 provides acid through acid pump 1014 and acid feed line 1016. The low pressure feed line 1020 enters into the 2-stage pump system of RO feed pump 1018 and RO feed pump 1022, which then exits as the high pressure main RO feed line 1024. A low pressure feed bypass 1030 line channels to the energy recover device 1052 and exits to the feed booster pump 1032 as the high pressure RO make up feed line 1028. The high pressure combined RO feed line 1026 enters the RO vessel 1034 and exits as permeate line 1036 and concentrate line 1044, which enters the inter-bank booster pump 1048 and exits as RO feed line 1054. Line 1054 enters the RO vessel 1042 and exits as permeate line 1040, which joins with permeate line 1036 to discard product water 1038. Concentrate line 1050 from vessel 1042 enters the energy recovery device 1052 and exits as the low pressure brine line 1056.

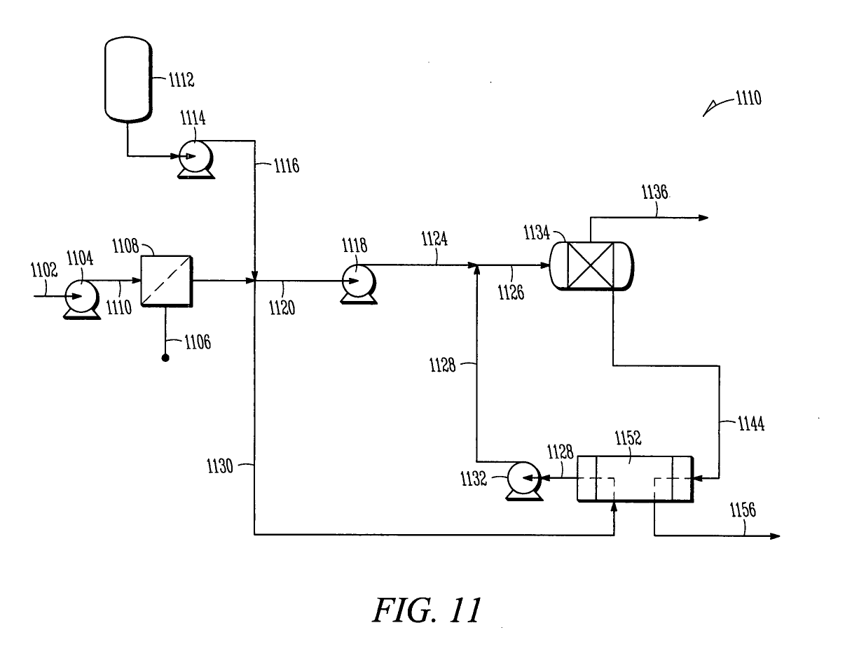

FIG. 11 illustrates a diagram of a 1-stage RO desalination system 1100, according to some embodiments of the invention. The seawater feed 1102 may be fed through a filter pump 1104, through the filter feed 1110 and into a filter 1108. The filter solids 1106 are removed. An acid tank 1112 provides acid through acid pump 1114 and acid feed line 1116. The low pressure feed line 1120 enters into the 1-stage pump system of RO feed pump 1118, which then exits as the high pressure main RO feed line 1124. A low pressure feed bypass 1130 line channels to the energy recover device 1152 and exits to the feed booster pump 1132 as the high pressure RO make up feed line 1128. The high pressure RO feed line 1126 enters the RO vessel 1134 and exits as permeate line 1136 and concentrate line 1144, which enters the energy recovery device 1152 and exits as the low pressure brine line 1156.

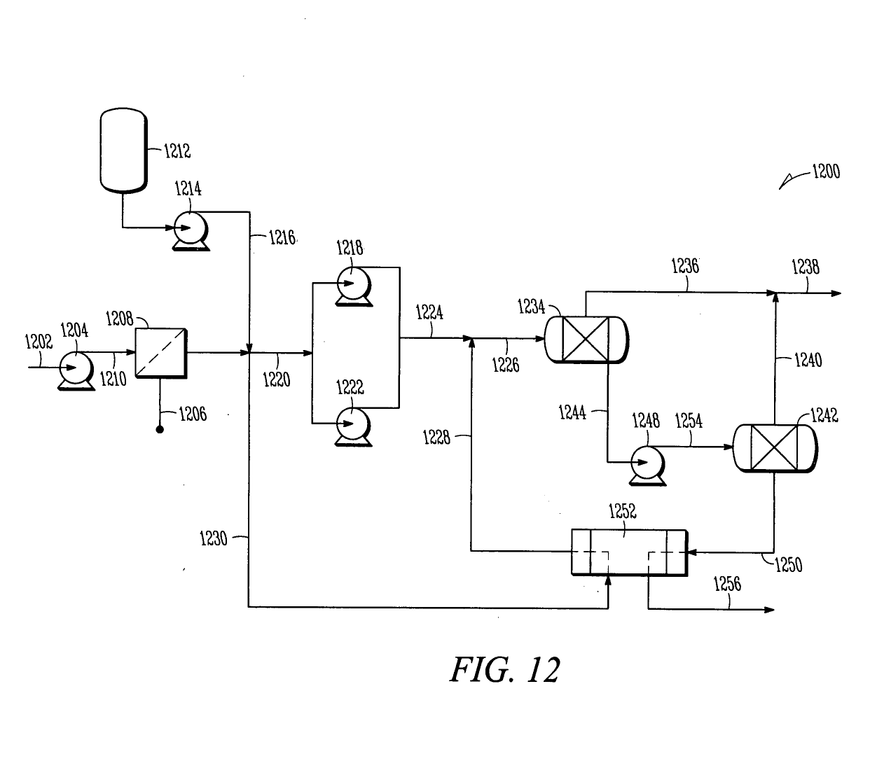

FIG. 12 illustrates a diagram of a 2-stage RO desalination system 1200 utilizing an inter-bank boost pump 1248, according to some embodiments of the invention. The seawater feed 1202 may be fed through a filter pump 1204, through the filter feed 1210 and into a filter 1208. The filter solids 1206 are removed. An acid tank 1212 provides acid through acid pump 1214 and acid feed line 1216. The low pressure feed line 1220 enters into the 2-stage pump system of RO feed pump 1218 and RO feed pump 1222, which then exits as the high pressure main RO feed line 1224. A low pressure feed bypass 1230 line channels to the energy recover device 1252 and exits as the high pressure RO make up feed line 1228. The high pressure combined RO feed line 1226 enters the RO vessel 1234 and exits as permeate line 1236 and concentrate line 1244, which enters the inter-bank booster pump 1248 and exits as RO feed line 1254. Line 1254 enters the RO vessel 1242 and exits as permeate line 1240, which joins with permeate line 1236 to discard product water 1238. Concentrate line 1250 from vessel 1242 enters the energy recovery device 1252 and exits as the low pressure brine line 1256.

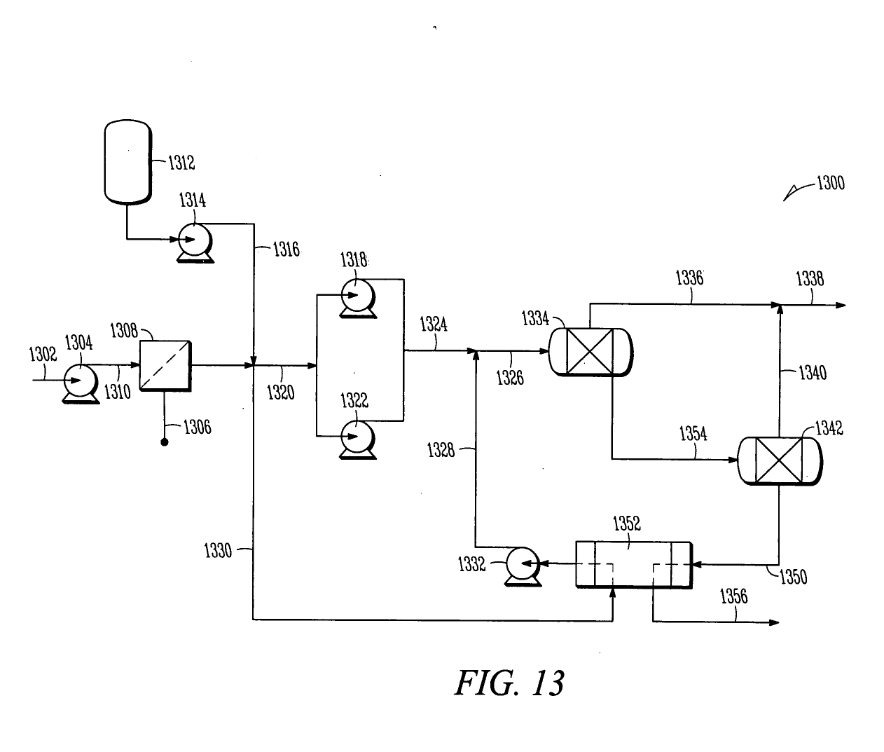

FIG. 13 illustrates a diagram of a 2-stage RO desalination system 1300 utilizing a feed booster pump 1332, according to some embodiments of the invention. The seawater feed 1302 may be fed through a filter pump 1304, through the filter feed 1310 and into a filter 1308. The filter solids 1306 are removed. An acid tank 1312 provides acid through acid pump 1314 and acid feed line 1316. The low pressure feed line 1320 enters into the 2-stage pump system of RO feed pump 1318 and RO feed pump 1322, which then exits as the high pressure main RO feed line 1324. A low pressure feed bypass 1330 line channels to the energy recover device 1352 and exits to the feed booster pump 1332 as the high pressure RO make up feed line 1328. The high pressure combined RO feed line 1326 enters the RO vessel 1334 and exits as permeate line 1336 and as RO feed line 1354. Line 1354 enters the RO vessel 1342 and exits as permeate line 1340, which joins with permeate line 1336 to discard product water 1338. Concentrate line 1350 from vessel 1342 enters the energy recovery device 1352 and exits as the low pressure brine line 1356.

Wind Desalination Design Optimization

Typically, RO desalination technology has been developed for operation at nearly constant conditions, except for trimming plant setpoints to account for long-term variations in membrane degradation, and changes in water temperature and salinity. In cases where the grid power is not available or expensive, the hybrid RO system needs to operate under large variations in available power and the economical viability of the wind desalination technology largely depends on the ability of the RO plant to produce water in most of this range. Possible plant configurations are meant to provide a great degree of flexibility to operate the wind desalination system in a wide range of conditions dictated by available power and feedwater state. Using the physical and economic models, in combination with optimization techniques, desalination plant size may be defined as well as the location in the operating space to minimize the resulting cost of water.

Grid Isolated Design Choices

In order to define the cost of water for a grid isolated configuration, the size of the RO subsystem, operating strategy and energy storage size may be defined utilizing the following steps:

1. For all the range of possible power levels from a 1.5 MW wind turbine an optimization problem may be solved to obtain the maximum water production subject to all the operating constraints. As a result, the upper bound of number of RO vessels may be obtained, as well as the optimal setpoints for associated operating strategies.

2. The optimal number of vessels may be obtained by calculating the cost of water for every RO plant size and selecting the one with the lowest associated cost.

3. The energy storage is sized, based on wind statistical information.

Grid Isolated Results

Defining the plant operation consists in calculating the setpoints of the available control knobs that will lead to minimal cost of water, at all possible power levels. Regarding the RO configuration, this involves calculating the optimal number of RO vessels in the RO bank, S, the optimal speed of the high-pressure (HP) pump, N1, and of the booster pump (BS), N2, the optimal valve opening for permeate recycle, V1, in the range of 70 kW to 1500 kW of consumed power. To achieve minimum COW, the maximization of water production can be used as the optimization criteria. Therefore, the RO operation setpoints are defined by maximizing the permeate flowrate subject to the operation constraints previously defined and that the power consumed by the pumps is fixed.

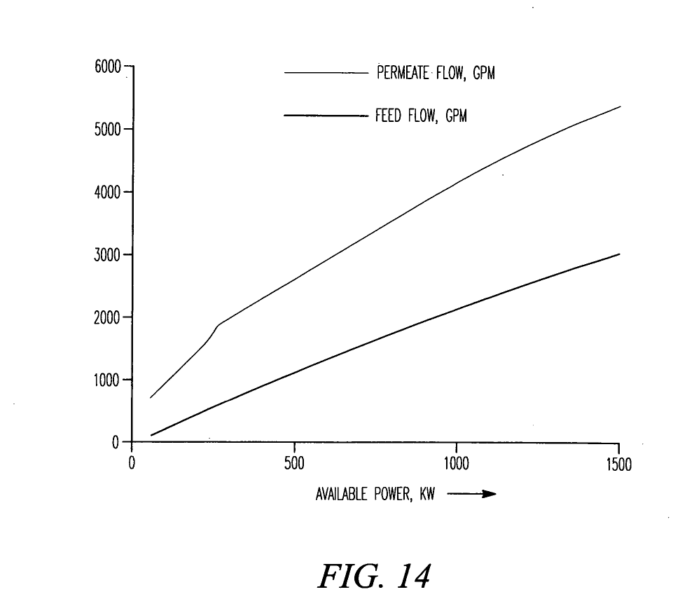

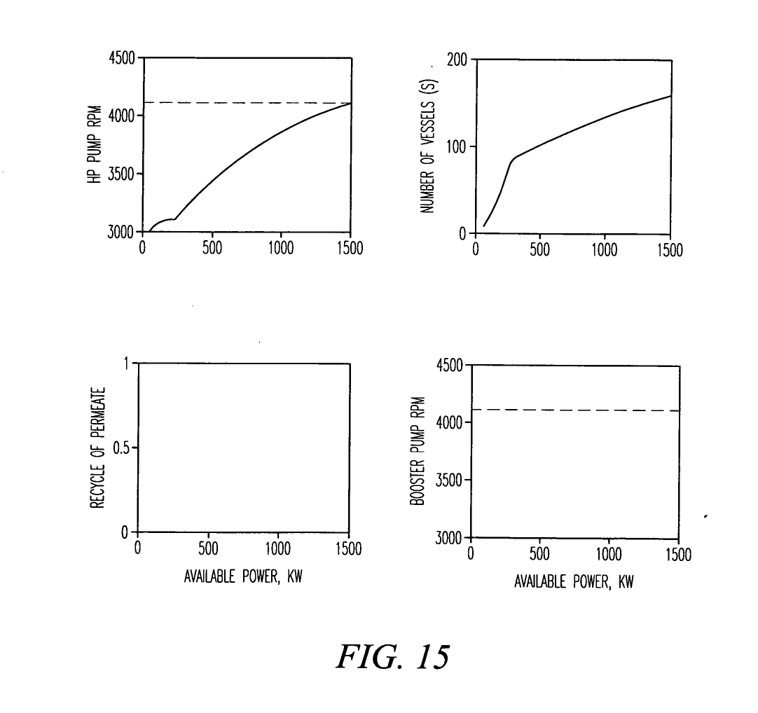

Referring to FIG. 14, a graphical view of the maximum permeate flow as a function of available power is shown, according to some embodiments of the invention. Referring to FIG. 15, a graphical view of the optimal operating parameters as a function of available power is shown, according to some embodiments of the invention. The dotted lines represent the available parameter variation ranges. Table 6 displays the optimal operating parameters for the example configuration.

TABLE 6

| Available | Optimal | Optimal | Optimal | Optimal | Maximum permeate flow, | Optimal |
|---|---|---|---|---|---|---|
| Power, kW | N1, rpm | N2, rpm | S(vessels) | recycle | gpm | recovery |
| 70 | 3000 | 3000 | 9 | 0 | 117.37 | 0.16168 |
| 120 | 3000 | 3000 | 25 | 0 | 244.16 | 0.24751 |
| 170 | 3040.3 | 3000 | 41 | 0 | 364.94 | 0.29296 |
| 220 | 3072 | 3000 | 58 | 0 | 487.22 | 0.32123 |
| 270 | 3070.6 | 3000 | 83 | 0 | 623.15 | 0.33394 |
| 320 | 3146.8 | 3000 | 88 | 0 | 734.04 | 0.35931 |
| 370 | 3216.1 | 3000 | 92 | 0 | 842.85 | 0.38077 |
| 420 | 3280.2 | 3000 | 96 | 0 | 950.15 | 0.39927 |
| 470 | 3340 | 3000 | 100 | 0 | 1056.8 | 0.41567 |
| 520 | 3396.7 | 3000 | 103 | 0 | 1162.7 | 0.43022 |
| 570 | 3450.7 | 3000 | 107 | 0 | 1268.2 | 0.44332 |
| 620 | 3502.4 | 3000 | 110 | 0 | 1373.4 | 0.4552 |
| 670 | 3552.2 | 3000 | 113 | 0 | 1478.5 | 0.46605 |
| 720 | 3600.2 | 3000 | 117 | 0 | 1583.2 | 0.476 |
| 770 | 3646.6 | 3000 | 120 | 0 | 1687.7 | 0.48517 |
| 820 | 3691.5 | 3000 | 123 | 0 | 1791.6 | 0.49383 |
| 870 | 3735 | 3000 | 126 | 0 | 1894.9 | 0.50147 |
| 920 | 3777.1 | 3000 | 129 | 0 | 1997.2 | 0.50872 |
| 970 | 3817.9 | 3000 | 132 | 0 | 2098.4 | 0.51545 |
| 1020 | 3857.3 | 3000 | 135 | 0 | 2198.2 | 0.52169 |
| 1070 | 3895.4 | 3000 | 138 | 0 | 2296.2 | 0.52748 |
| 1120 | 3932.1 | 3000 | 140 | 0 | 2392.3 | 0.53285 |
| 1150 | 3953.5 | 3000 | 142 | 0 | 2449 | 0.53589 |
| 1200 | 3988 | 3000 | 144 | 0 | 2541.5 | 0.54066 |
| 1250 | 4021.2 | 3000 | 147 | 0 | 2631.6 | 0.54508 |
| 1300 | 4053 | 3000 | 149 | 0 | 2719.1 | 0.54919 |
| 1350 | 4083.4 | 3000 | 152 | 0 | 2803.9 | 0.55301 |
| 1400 | 4112.5 | 3000 | 154 | 0 | 2885.9 | 0.55656 |
| 1450 | 4140.2 | 3000 | 156 | 0 | 2965.2 | 0.55986 |
| 1500 | 4166.7 | 3000 | 158 | 0 | 3041.8 | 0.56294 |

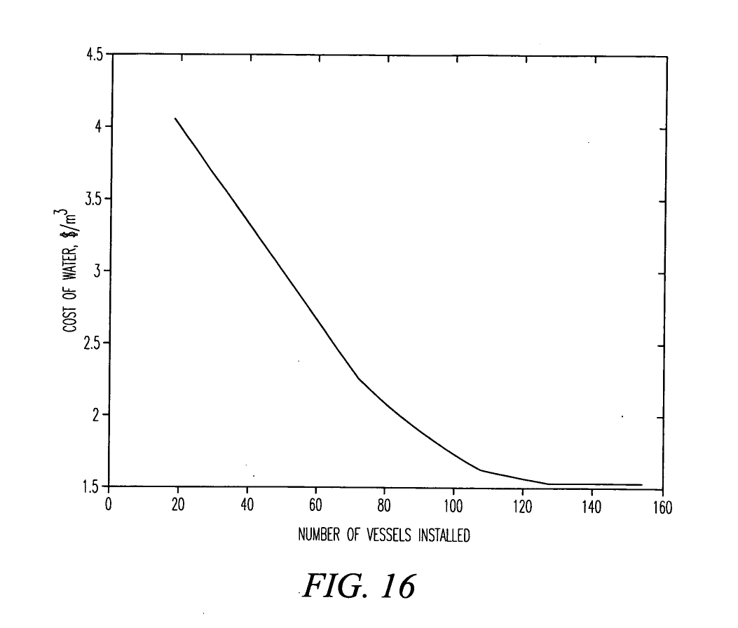

As a second step in determining the optimal RO plant size, the expected cost of water can be calculated for all plant sizes using the COW model described earlier. As an example, a location may be chosen with a yearly average wind speed of 7 m/s. The parameters characterizing the Weibull probability density function for mean wind speeds at standard height are in this case A10 m=7.9 and k=2. At hub height, hhub=70 m, the yearly average wind speed is 9.24 m/s, and the parameters of the Weibull probability density function are Ahub=10.43 and k=2. Once the available power for each wind speed is computed, the optimal operating points for each wind speed are determined. The average yearly specific cost of water considering plants with different numbers of installed RO vessels can be computed, as previously presented. Referring to FIG. 16, a graphical view of the annual average cost of water for a desalination plant configuration, operated as grid-isolated, as a function of the number of RO vessels installed is shown, according to some embodiments of the invention.

Grid Connected Design Choices

Given the greater flexibility of a grid connected topology, there are many opportunities for optimal design and optimal operation calculations. For the grid connected case, there is a focus on analyzing the viability of a wind powered RO technology and understanding in what conditions it will be preferred instead of an RO plant power only with grid energy. A simple operating strategy has been chosen to compute a detailed cost of water for this topology. In addition, an optimal operation strategy is suggested for dealing with the energy management between wind power, grid power and energy storage subsystem.

Plant Operation

The constant operation of a wind RO plant according to the embodiments of the invention is one of many possible operating strategies. For the same capital expenditure, the plant operator may prefer to produce less water when grid power is expensive (decreasing the operating costs) and increase water production when wind is available. Accordingly, the optimal size of RO plant is closely dependent on the chosen strategy.

For a grid-connected operation, the plant setpoints include not only the grid-isolated topology setpoints (water pump speeds, number of active vessels, recirculation flows), but also the ones corresponding to the power management: power used by the RO plant, power bought or sold to the grid, and power drawn from or stored in the batteries (if available). The operation of a wind RO plant can take into account the forecast for wind speeds, and energy prices to make well-informed decisions to manage the energy storage. One possibility to achieve this is to use receding-horizon techniques that continuously correct the operating setpoints to maximize a performance criterion. In the context of a grid-connected wind RO plant, this strategy can be defined by solving optimization problems of the following sort:

TABLE 7

| | |
|---|---|
| Minimize | ${\sum }_{k = 1}^{N} {COW}_{k} \vert$ |
| Subject to | RO operational constraints\| |

Energy storage constraints
S < Smax (RO plant size)
Q̅ₚ > Q̅ₚ demand
C̅ₚ < C̅ₚ max

Where the optimization is performed with respect to the wind RO plant setpoints, during a period of time spanning N steps, Smax is the maximum number of vessels in the RO plant, Q̅ₚ and C̅ₚ are respectively, the average permeate flow and permeate concentration during the following N steps, and the limits Q̅ₚ min and C̅ₚ max depend on the local water regulations.

The models as described by the embodiments of the present invention may also be adapted to calculate optimal strategies to account for switching behavior of vessels and energy recovery devices. This may call for an optimal strategy that accounts for restrictions in vessel and ERD operation and may also provide a method to determine the optimal size of membrane and energy recovery banks.

The embodiments described herein are examples of methods and systems having elements corresponding to the elements of the invention recited in the claims. This written description may enable one of ordinary skill in the art to make and use embodiments having alternative elements that likewise correspond to the elements of the invention recited in the claims. The scope thus includes methods and systems that do not differ from the literal language of the claims, and further includes other methods and systems with insubstantial differences from the literal language of the claims. While only certain features and embodiments have been illustrated and described herein, many modifications and changes may occur to one of ordinary skill in the relevant art. The appended claims are intended to cover all such modifications and changes.

What is claimed is:

1. A method for controlling a desalination system, comprising:
evaluating physical models, sufficient to identify physical constraints, including variations of a source; and
evaluating economic models;
wherein said evaluating physical and economic models provides a preliminary design configuration of the desalination system for reduction of cost of water and for provision of operating strategies.

2. The method of claim 1, wherein the desalination system is a reverse osmosis desalination system comprising at least one effector for modifying an operating point of the desalination system.

3. The method of claim 2, wherein the at least one effector includes a plurality of valves configured and positioned to render one or more vessels active or inactive during operation.

4. The method of claim 2, wherein the at least one effector includes a plurality of valves configured and positioned to adjust one or more of water flow, pressures, and recovery ratio during operation.

5. The method of claim 2, wherein the at least one effector includes at least one variable frequency drive for modifying water flows and pressure heads.

6. The method of claim 2, wherein said evaluating physical models comprises evaluating a distribution of pressures, flows and concentrations throughout the desalination system in response to the action of the effectors and in response to external disturbances.

7. The method of claim 6, wherein the external disturbances include variations in feed water temperature or concentration.

8. The method of claim 1, wherein said evaluating economic models comprises predicting the cost of water in terms of an itemized cost of each system component, a statistical description of renewable power sources, and water production.

9. The method of claim 1, wherein the desalination system is at least partially powered by a renewable energy source.

10. The method of claim 9, wherein the renewable energy source is wind.

11. The method of claim 1, wherein the physical models comprise at least one of models of wind turbines, pumps, valves, membrane vessels, energy recovery devices, energy storage devices, or combinations thereof.

12. A method for controlling a reverse osmosis desalination system, comprising:
evaluating physical models of wind turbines, pumps, valves, membrane vessels, energy recovery devices, and energy storage devices sufficient to identify the physical constraints; and
evaluating economic models;
wherein said evaluating physical and economic models provides a preliminary design configuration of the desalination system for reduction of cost of water and for provision of operating strategies.

13. The method of claim 12, wherein said evaluating physical models comprises evaluating a distribution of pressures, flows and concentrations throughout the desalination system in response to external disturbances.

14. The method of claim 13, wherein the external disturbances include variations in feed water temperature or concentration.

15. The method of claim 13, wherein the external disturbances include variations in the power supplied to the desalination system.

16. The method of claim 12, wherein said evaluating economic models comprises predicting the cost of water in terms of an itemized cost of each system component, a statistical description of renewable power sources, and water production.

17. A desalination system, comprising:
a power source; and
one or more water filtration units;
wherein the configuration, size, and/or placement of said power source and said water filtration units is at least partially determined by an evaluation of both physical and economic models which lower cost of water.

18. The desalination system of claim 17, wherein the desalination system is a reverse osmosis desalination system comprising at least one effector for modifying an operating point of the desalination system.

19. The desalination system of claim 18, wherein the at least one effector includes a plurality of valves configured and positioned to render one or more vessels active or inactive during operation.

20. The desalination system of claim 18, wherein the at least one effector includes a plurality of valves configured and positioned to adjust one or more of water flow, pressures, and recovery ratio during operation.

21. The desalination system of claim 18, wherein the at least one effector includes at least one variable frequency drive for modifying water flows and pressure heads.

22. The desalination system of claim 18, wherein the physical models model a distribution of pressures, flows and concentrations throughout the desalination system in response to the action of the effectors and in response to external disturbances.

23. The desalination system of claim 22, wherein the external disturbances include variations in feed water temperature or concentration.

24. The desalination system of claim 22, wherein the external disturbances include variations in the power supplied to the desalination system.

25. The desalination system of claim 18, wherein the economic models predict the cost of water in terms of an itemized cost of each system component, a statistical description of renewable power sources, and water production.

26. The desalination system of claim 17, wherein the power source is a renewable energy source.

27. The desalination system of claim 26, wherein the renewable energy source is a variable energy source.

28. The desalination system of claim 27, wherein said variable energy source comprises wind energy.

29. The desalination system of claim 17, wherein the one or more water filtration units comprise one or more reverse osmosis vessels.

30. The desalination system of claim 17, further comprising an energy storage device.

31. The desalination system of claim 17, further comprising an energy recovery device.
